(19) United States
(12) Patent Application Publication
(10) Pub. No.: US 2005/0155162 A1
(43) Pub. Date: Jul. 21, 2005

(54) Process for the coloration of aluminium

(76) Inventors: Hans-Thomas Schacht, Rheinfelden (DE); Gibert Moegle, Magstatt-le-Bas (FR); Didier Bauer, Kembs (FR); Leonhard Feiler, Binzen (DE); Olof Wallquist, Therwill (CH); Martin Muller, Lorrach (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/503,152

(22) PCT Filed: Jan. 28, 2003
(86) PCT No.: PCT/EP03/00817

(30) Foreign Application Priority Data
Feb. 6, 2002 (EP) 02405083.3
Mar. 26, 2002 (EP) 02405237.5

(51) Int. Cl. C09C 1/62; C08K 5/00; D06P 5/00

(52) U.S. Cl. 8/502; 106/404; 106/499

(57) ABSTRACT

The present invention relates to a proces for producing colored oxide layers on aluminum or on aluminum alloys by dyeing in an aqueous dye bath, rinsing with water and sealing, wherein there is used for the dyeing at least one dye of the general formula 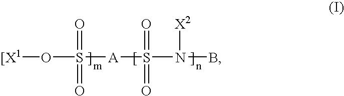 wherein m is a value from 1 to 8, especially from 1 to 4, n is a value from 0 to 7, especially from 1 to 4, the sum of m and n being less than or equal to 8, A is the radical of a chromophore of the 1-aminoanthraquinone, anthraquinone, anthrapyrimidine, azo, azomethine, benzodifuranone, quinacridone, quinacridonequinone, quinophthalone, diketopyrrolopyrrole, dioxazine, flavanthrone, indanthrone, indigo, isoindoline, isoindolinone, isoviolanthrone, perinone, perylene, phthalocyanine, pyranthrone or thioindigo series,
B is a hydrogen atom, a branched or straight-chain C₁₋₈alkyl, C₂₋₈alkenyl or C₂₋₈alkynyl radical, an aryl radical, an N—, O— or S-containing 5- or 6-membered heterocyclic ring, or a C₁₋₈alkyl-arylene, aryl-C₁₋₈alkylene or aryl-L-arylene radical, each of which may be substituted by one or more groups —OH, —Ocat, —COOH, —COOcat, —SH, —Scat, —OR¹, —SR², —C(O)OR³, —C(O)R⁴, —NR⁵R⁶, it being possible for the C₁₋₈alkyl radical to be uninterrupted or interrupted one or more times by —O— or by —S—,
R¹, R², R³ and R⁴ are each independently of the others a C₁₋₈alkyl radical, C₇₋₁₁aralkyl radical or C₆₋₁₀aryl radical and R⁴ additionally may be a hydrogen atom,
L is a bond, is —NR⁷ wherein R⁷ is a hydrogen atom or a C₁₋₄alkyl radical, or is a —N═N— group, and R⁵ and R⁶ are each independently of the other a hydrogen atom, a C₁₋₈-alkyl radical, a C₁₋₄alkoxy-C₁₋₄alkyl radical, a C₆₋₁₀aryl radical, a C₇₋₁₁aralkyl radical or a —(CH₂)ₒOH radical wherein o is an integer from 2 to 6,
X¹ is a hydrogen atom or cat and
X² is a hydrogen atom or cat, cat being a cation, and to the colored substrates obtained according to such a process.
   Compared with commercially available dyes and dyes of formula I in which cat⁺ is an alkali metal, the dyeings obtainable according to the process of the invention have surprisingly high light-fastness properties.

The present invention relates to a process for producing colored oxide layers on aluminum or on aluminum alloys and to the colored substrates obtained by such a method. Surprisingly high light-fastness properties of dyeings are obtainable using the method according to the invention.

Colored objects, articles or parts made of aluminum or aluminum alloys and that are provided with a protective oxide layer, especially an oxide layer produced by galvanic means by anodisation, are nowadays increasingly being used as components of buildings and of transportation means or vehicles, or for the decoration thereof, or for basic consumer goods or works of art. It is desired that the properties of the colored layers in terms of fastness to environmental effects, especially the effect of sunlight, be as high as possible.

Various initiatives have been taken to solve this problem. For example, dyes of a particular structure, for example the 1:2 chromium complex dyes described in WO 98/54264 and WO 98/58025, have been used, or certain sealing processes, as described in WO 01/21860 and EP-A-1 087 038, have been used, by means of which an improvement in light fastness can be obtained, but the improvement is inadequate for articles that are to be used for external architecture.

It has now, surprisingly, been found that the light fastness properties of aluminum dyeings can be very markedly increased by using a dye of formula (I) as described hereinbelow to color the aluminum oxide layers.

The present invention accordingly relates to a process for producing colored oxide layers on aluminum or on aluminum alloys by dyeing in an aqueous dyeing bath, rinsing with water and sealing, wherein there is used for the dyeing at least one dye of the general formula 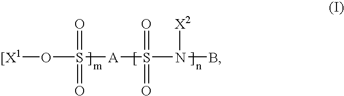
wherein m is a value from 1 to 8, especially from 1 to 4,
n is a value from 0 to 7, especially from 1 to 4, the sum of m and n being less than or equal to 8,
A is the radical of a chromophore of the 1-aminoanthraquinone, anthraquinone, anthrapyrimidine, azo, azomethine, benzodifuranone, quinacridone, quinacridonequinone, quinophthalone, diketopyrrolopyrrole, dioxazine, flavanthrone, indanthrone, indigo, isoindoline, isoindolinone, isoviolanthrone, perinone, perylene, phthalocyanine, pyranthrone or thioindigo series,
B is a hydrogen atom, a branched or straight-chain C₁₋₈alkyl, C₂₋₈alkenyl or C₂₋₈alkynyl radical, an aryl radical, an N—, O— or S-containing 5- or 6-membered heterocyclic ring, or a C₁₋₈alkyl-arylene, aryl-C₁₋₈alkylene or aryl-L-arylene radical, each of which may be substituted by one or more groups —OH, —Ocat, —COOH, —COOcat, —SH, —Scat, —OR¹, —SR², —C(O)OR³, —C(O)R⁴, —NR⁵R⁶, it being possible for the C₁₋₈alkyl radical to be uninterrupted or interrupted one or more times by —O— or by —S—,
R¹, R², R³ and R⁴ are each independently of the others a C₁₋₈alkyl radical, C₇₋₁₁aralkyl radical or C₆₋₁₀aryl radical and R⁴ additionally may be a hydrogen atom,
L is a bond, is —NR⁷ wherein R⁷ is a hydrogen atom or a C₁₋₄alkyl radical, or is a —N═N— group, and R⁵ and R⁶ are each independently of the other a hydrogen atom, a C₁₋₈alkyl radical, a C₁₋₄alkoxy-C₁₋₄alkyl radical, a C₆₋₁₀aryl radical, a C₇₋₁₁aralkyl radical or a —(CH₂)ₒOH radical
wherein o is an integer from 2 to 6,
X¹ is a hydrogen atom or cat and
X² is a hydrogen atom or cat,
cat being a cation 1/z cat^{z+}, and to the substrates colored using that method, z indicating the number of the positive charges.

B may have different substituent meanings within a chromophore A.

In the group B, the radicals may be defined as follows:
Alkyl or alkylene may be straight-chain or branched.
C₁₋₈Alkyl is, for example, methyl, ethyl, n-propyl, isopropyl, n-butyl, sec-butyl, isobutyl, tert-butyl, n-pentyl, 2-pentyl, 3-pentyl, 2,2-dimethylpropyl, hexyl, heptyl, 2,4,4-trimethylpentyl, 2-ethylhexyl or octyl, which may be unsubstituted or substituted by —OH, —Ocat, —COOH, —COOcat, —SH, —Scat, —OR¹, —SR², —C(O)OR³, —C(O)R⁴ or by —NR⁵R⁶, wherein R¹, R², R³, R⁴, R⁵ and R⁶ are as defined hereinabove.

Examples of C₂₋₈alkenyl, which may also have two double bonds optionally isolated or conjugated, are vinyl, allyl, 2-propen-2-yl, 2-buten-1-yl, 3-buten-1-yl, 1,3-butadien-2-yl, 2-penten-1-yl, 3-penten-2-yl, 2-methyl-1-buten-3-yl, 2-methyl-3-buten-2-yl, 3-methyl-2-buten-1-yl and 1,4-pentadien-3-yl, which may be unsubstituted or substituted by —OH, —Ocat, —COOH, —COOcat, —SH, —Scat, —OR¹, —SR², —C(O)OR³, —C(O)R⁴ or by —NR⁵R⁶, wherein R¹, R², R³, R⁴, R⁵ and R⁶ are as defined hereinabove.

Preference is given especially to linear C₁₋₅alkyl and C₂₋₅alkenyl radicals terminally substituted by an —OH, —Ocat, —COOH, —COOcat, —SH, —Scat, —OR¹, —SR², —C(O)OR³, —C(O)R⁴ or —NR⁵R⁶ group.

C₂₋₈Alkyl interrupted one or more times by —O— or by —S— is interrupted, for example, 1, 2 or 3 times by —O— or by —S—, resulting, for example, in structural units such as —(CH₂)₂OCH₃, —(CH₂CH₂O)₂CH₂CH₃, —CH₂—O—CH₃, —CH₂CH₂—O—CH₂CH₃, —[CH₂CH₂O]_{y}-CH₃ wherein y=1-3, —CH₂—CH(CH₃)—O—CH₂-CH₂CH₃ and —CH₂-CH(CH₃)-O—CH₂-CH₃, which may be unsubstituted or substituted by —OH, —Ocat, —COOH, —COOcat, —SH, —Scat, —OR¹, SR², —C(O)OR³, —C(O)R⁴ or by —NR⁵R⁶.

Examples of C₂₋₈alkynyl include ethynyl, 1-propyn-1-yl, 2-butyn-1-yl, 3-butyn-1-yl, 2-pentyn-1-yl and 3-pentyn-2-yl.

C_{1-C}₈Alkylene is linear or branched alkylene, for example methylene, ethylene, propylene, isopropylene, n-butylene, sec-butylene, isobutylene, tert-butylene, pentylene, hexylene, heptylene, —CH(CH₃)-CH₂-, —CH(CH₃)-(CH₂)₂-, —CH(CH₃)-(CH₂)₃-, —C(CH₃)₂-CH₂- or 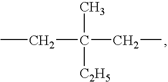
preference being given to alkylene radicals having from 1 to 5 carbon atoms.

When the alkylene radical is substituted by —O— or by —S—, examples of the resulting structural units include —CH₂-O—CH₂-, —CH₂CH₂-O—CH₂CH₂-, —CH₂-CH(CH₃)-O—CH₂-CH(CH₃)-, —CH₂-S—CH₂-, —CH₂CH₂-S—CH₂CH₂- and —CH₂CH₂CH₂-S—CH₂CH₂CH₂-.

Examples of a C₁₋₈alkoxy radical that may be linear or branched include methoxy, ethoxy, n-propoxy, isopropoxy, n-butoxy, sec-butoxy, isobutoxy, tert-butoxy, n-pentyloxy, 2-pentyloxy, 3-pentyloxy, 2,2-dimethylpropoxy, n-hexyloxy, n-heptyloxy, n-octyloxy, 1,1,3,3-tetramethyl-butoxy and 2-ethylhexyloxy. According to the present invention, aryl is to be understood to mean especially an aryl radical having from 6 to 10 carbon atoms, for example phenyl, naphthyl or biphenyl, that may be substituted one, two or three times by linear or branched C₁₋₄alkyl, such as methyl, ethyl, n-propyl, isopropyl, n-butyl, isobutyl, sec-butyl or tert-butyl, by linear or branched C₁₋₄alkoxy, such as methoxy, ethoxy, n-propoxy, isopropoxy, n-butoxy, isobutoxy, sec-butoxy or tert-butoxy, by linear or branched C₁₋₄alkylthio, such as methylthio, ethylthio, n-propylthio, isopropylthio, n-butylthio, isobutylthio, sec-butylthio or tert-butylthio, by —OH, —SH, —COOH, —Ocat, —Scat, —COOcat or by a group (CH₂)e-E, wherein e is an integer from 1 to 6, especially 2 or 3, and E is a hydrogen atom or a group —OH, —Ocat, —SH, —Scat, —OR¹, —SR², —C(O)OR³, —C(O)R⁴ or —NR⁵R⁶, wherein R¹, R², R³ and R⁴ are each independently of the others a C₁₋₄alkyl radical, especially methyl or ethyl, and R⁵ and R⁶ are a -(CH₂)ₒOH radical wherein o is an integer from 2 to 6, especially 2 or 3, and cat is an alkali metal cation, especially a sodium or potassium cation, unsubstituted ammonium or an ammonium cation.

Preference is given to phenyl groups, which may be substituted by one, two or three groups selected from —OH, methoxy, -(CH₂)₂OH, —cat and -(CH₂)₂Ocat, for example 3,4,5-trimethoxyphenyl, 4-hydroxyphenyl, 3-hydroxy-4-methoxyphenyl or 2-hydroxy-1-ethylphenyl. Examples of a C₇₋₁₁aralkyl radical, which may be unsubstituted or substituted, include benzyl, 2-benzyl-2-propyl, β-phenyl-ethyl, α,α-dimethylbenzyl and ω-phenyl-butyl.

An O—, S— or N-containing 5- or 6-membered heterocyclic ring is, for example, pyrrolyl, oxinyl dioxinyl, 2-thienyl, 2-furyl, 1-pyrazolyl, 2-pyridyl, 2-thiazolyl, 2-oxazolyl, 2-imidazolyl, isothiazolyl, triazolyl or any other ring system consisting of thiophene, furan, pyridine, thiazole, oxazole, imidazole, isothiazole, thiadiazole, triazole, pyridine and benzene rings and unsubstituted or substituted by from 1 to 6 ethyl, methyl, ethylene and/or methylene groups.

In the groups —OR¹, —SR², —C(O)OR³ and —C(O)R⁴, R¹, R², R³ and R⁴ may have, inter alia, the following meanings:
R¹, R², R³ and R⁴ denoting C₁₋₄alkyl are, for example, methyl, ethyl, n-propyl, isopropyl, n-butyl, isobutyl, sec-butyl or tert-butyl, preferably methyl or ethyl, and denoting C₆₋₁₂aryl are, for example, phenyl, biphenyl or naphthyl, preferably phenyl.

In the group —NR⁵R⁶, R⁵ and R⁶, in addition to being a hydrogen atom, are a C₁₋₄alkyl radical, for example methyl, ethyl, n-propyl, isopropyl, n-butyl, isobutyl, sec-butyl or tert-butyl, preferably methyl or ethyl, or a -(CH₂)ₒOH radical wherein o is an integer from 1 to 6, especially 2 or 3, and the nitrogen atom is preferably symmetrically substituted.

As has already been mentioned, B may have various substituent meanings according to chromophore A, and is more especially selected from the following substituents:
a hydrogen atom, -(CH₂)ₑ-E and 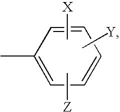
   wherein e is an integer from 1 to 6, especially 2 or 3, E is a hydrogen atom, an —OH, —Ocat, —SH, —Scat, —OR¹, —SR², —NR⁵R⁶ or —C(O)OR³ group, and X, Y and Z are each independently of the others selected from a hydrogen atom and the groups —OH, —Ocat, —SH, —Scat, —OR¹, —SR², —NR⁵R⁶ and —C(O)OR³, R¹, R² and R³each independently of the others being a C₁₋₄alkyl radical, especially methyl or ethyl, R⁵ und R⁶ being a -(CH₂)ₒOH radical wherein o is an integer from 2 to 6, and cat being a sodium or potassium cation or unsubstituted ammonium or being an ammonium cation described hereinbelow to which preference is given.
X¹ and X² may each be a hydrogen atom or a cation cat.

Suitable cations cat in formulae (I), (II) and (III)—and in the groups —Ocat, —COOcat and —Scat—are generally radicals that are capable of forming water-soluble salts with the sulfonic acids or sulfonamides.

They include, for example, alkaline earth metal cations, such as strontium and calcium cations, alkali metal cations, especially lithium, sodium and potassium cations, and quaternary ammonium cations, especially unsubstituted ammonium and ammonium cations of formula ⁺NR³¹R³²R³³R³⁴, wherein R³¹, R³², R³³ and R³⁴ are each independently of the others a hydrogen atom, a straight-chain or branched C₁₋₃₂alkyl radical, especially a C₁₋₁₆alkyl radical, which may be unsubstituted or substituted by one or more C₁₋₄alkoxy radicals, a straight-chain or branched C₂₋₁₆alkenyl radical , a hydroxy-C₁₋₈alkyl radical, especially a hydroxy-C₁₋₄alkyl radical, or a C₆₋₂₄aryl radical, especially a C₆₋₁₂aryl radical, unsubstituted or substituted by one or more C₁₋₄alkyl radicals, C₁₋₄alkoxy radicals or hydroxy groups, especially a phenyl group substituted by a hydroxy group, or a C₇₋₂₄aralkyl radical, especially a C₇₋₁₁aralkyl radical, unsubstituted or substituted by one or more C₁₋₄alkyl radicals, C₁₋₄alkoxy radicals or hydroxy groups, such as phenyl-C₁₋₄alkylene, wherein at least one of the radicals R³¹, R³², R³³ and R³⁴ is other than a hydrogen atom, or two of the radicals R³¹, R³², R³³ and R³⁴, together with the nitrogen atom to which they are bonded, form a 5- or 6-membered ring that may contain additional hetero atoms, for example S, N or O.

The following are examples of especially preferred ammonium cations:
unsubstituted ammonium,
mono-, di-, tri- or tetra-C₁₋₄alkylammonium, such as methylammonium, ethylammonium, 3-propylammonium, isopropylammonium, butylammonium, sec-butylammonium, isobutyl-ammonium, 1,2-dimethylpropylammonium or 2-ethylhexylammonium, dimethylammonium, diethylammonium, dipropylammonium, diisopropylammonium, dibutylammonium, diisobutyl-ammonium, di-sec-butylammonium, di-2-ethylhexylammonium, N-methyl-n-butylammonium or N-ethyl-n-butylammonium, trimethylammonium, triethylammonium, tripropylammonium, tributylammonium, N,N-dimethylethylammonium, N,N-dimethylisopropylammonium, N,N-dimethylbenzylammonium or (CH₃)₂((CH₃O)₂CHCH₂)NH⁺,
mono-, di-, tri- or tetra-C₈₋₁₆alkylammonium, such as 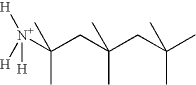
   (notional representation of the ammonium cation of Primene 81R®),
C₁₋₄alkoxy-C₁₋₄alkylammonium, such as 2-methoxyethylammonium, bis(2-methoxyethyl)-ammonium, 3-methoxypropylammonium or ethoxypropylammonium,
mono-, di- or tri-(hydroxy-C₁₋₄alkyl)ammonium, such as mono-, di- or tri-ethanolammonium, mono-, di- or tri-isopropanolammonium, N-methyl- or N,N-dimethyl-ethanolammonium, -propanolammonium or -isopropanolammonium, N-methyl-diethanolammonium, -dipropanol-ammonium or -diisopropylammonium, N-ethyl-diethanolammonium, -dipropanolammonium or -diisopropylammonium, N-propyl-diethanolammonium, -dipropanolammonium or -diisopropyl-ammonium,
N-(2-hydroxyethyl)pyrrolidinium, N-(2- or 3-hydroxypropyl)pyrrolidinium, N-(2-hydroxyethyl)-piperidinium, N-(2- or 3-hydroxypropyl)piperidinium, N-(2-hydroxyethyl)morpholinium, N-(2- or 3-hydroxypropyl)morpholinium or N-(2-hydroxyethyl)piperazinium, and 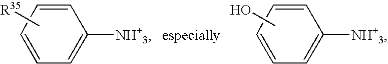
   such as 2-, 3- or 4-hydroxyphenylammonium, wherein R³⁵ is a hydroxy group, a C₁₋₈alkoxy group, a carboxylic acid group or COOR³⁶ in which R³⁶ is a C₁₋₈alkyl group, C₆₋₁₀aryl group or C₇₋₁₁aralkyl group. Tetramethylammonium and tetraethylammonium salts are suitable especially for inkjet printing.

Ammonium cations of formula 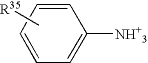
may assist in increasing light-fastness. Polyammonium salts, especially diammonium compounds, are likewise suitable. Preferred diammonium compounds are derived from the following amines: 1,2-diaminoethane, 1,2-diamino-1-methylethane, 1,2-diamino-1,2-dimethylethane, 1,2-diamino-1,1-dimethylethane, 1,2-diaminopropane, 1,3-diaminopropane, 1,3-diamino-2-hydroxypropane, N-methyl-1,2-diaminoethane, 1,4-diazacyclohexane 1,2-diamino-1,1-dimethylethane, 2,3-diaminobutane, 1,4-diaminobutane, N-hydroxyethyl-1,2-diaminoethane, 1-ethyl-1,3-diaminopropane, 2,2-dimethyl-1,3-diaminopropane, 1,5-diaminopentane, 2-methyl-1,5-diaminopentane, 2,3-diamino-2,3-dimethylbutane, N-2-aminoethylmorpholine, 1,6-diaminohexane, 1,6-diamino-2,2,4-trimethylhexane, N,N-dihydroxyethyl-1,2-diaminoethane, N,N-dimethyl-1,2-diamino-ethane, 4,9-dioxa-1,12-diaminododecane, 1,2-diaminocyclohexane, 1,3-diamino-4-methyl-cyclohexane, 1,2-diaminocyclohexane, 1-amino-2-aminomethyl-2-methyl-4,4-dimethyl-cyclohexane, 1,3-diaminomethylcyclohexane, N-2-aminoethylpiperazine, 1,1-di(4-amino-cyclohexyl)methane, 1,1-di(4-aminophenyl)methane, N,N′-diisopropyl-p-phenylenediamine, N,N′-di-sec-butyl-p-phenylenediamine, N,N′-bis(1,4-dimethyl-pentyl)-p-phenylenediamine, N,N′-bis(1-ethyl-3-methyl-pentyl)-p-phenylenediamine, N,N′-bis(1-methyl-heptyl)-p-phenylene-diamine, N,N′-dicyclohexyl-p-phenylenediamine, N,N′-diphenyl-p-phenylenediamine, N,N′-di(2-naphthyl)-p-phenylenediamine, N-isopropyl-N′-phenyl-p-phenylenediamine, N-(1,3-dimethyl-butyl)-N′-phenyl-p-phenylenediamine, N-(1-methyl-heptyl)-N′-phenyl-p-phenylenediamine, N-cyclohexyl-N′-phenyl-p-phenylendiamine and N,N′-dimethyl-N,N′-di-sec-butyl-p-phenylene-diamine.

A preferred embodiment concerns a process for producing colored oxide layers on aluminum or on aluminum alloys by dyeing in an aqueous dye bath, rinsing with water and sealing, wherein there is used for the dyeing at least one dye of the general formula 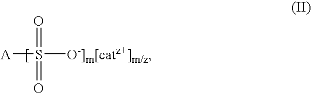
wherein m is a value from 1 to 8, especially from 1 to 4,
A is the radical of a chromophore of the 1-aminoanthraquinone, anthraquinone, anthrapyrimidine, azo, azomethine, benzodifuranone, quinacridone, quinacridonequinone, quinophthalone, diketopyrrolopyrrole, dioxazine, flavanthrone, indanthrone, indigo, isoindoline, isoindolinone, isoviolanthrone, perinone, perylene, phthalocyanine, pyranthrone or thioindigo series and
cat is an alkaline earth metal cation, especially Ca²⁺, unsubstituted ammonium or an ammonium cation, and to the substrates colored by such a process.

The dyes of the general formula (II) hereinabove that can be used in that embodiment are generally derived from compounds in which A is the radical of a chromophore of the 1-aminoanthraquinone, anthraquinone, anthrapyrimidine, azo, azomethine, benzodifuranone, quinacridone, quinacridonequinone, quinophthalone, diketopyrrolopyrrole, dioxazine, flavanthrone, indanthrone, indigo, isoindoline, isoindolinone, isoviolanthrone, perinone, perylene, phthalocyanine, pyranthrone or thioindigo series.

The number of sulfonic acid groups very strongly depends on the chromophore A, but is generally from 1 to 8 and preferably from 1 to 4.

The ammonium cation is generally a cation of the following formula 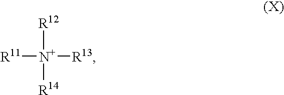
wherein R¹¹, R¹², R¹³ and R¹⁴ are a hydrogen atom, a straight-chain or branched C₁₋₃₆alkyl radical, preferably C₁₋₁₆alkyl radical, which may be unsubstituted or substituted, a straight-chain or branched hydroxy-C₁₋₃₆alkyl radical, especially hydroxy-C₁₋₈alkyl radical, an unsubstituted or substituted C₆₋₂₄aryl radical, especially C₆₋₁₀aryl radical, or an unsubstituted or substituted C₇₋₂₄aralkyl radical, especially C₇₋₁₂aralkyl radical, or two of the radicals R¹¹, R¹², R¹³ and R¹⁴, together with the nitrogen atom to which they are bonded, form a five- or six-membered heterocyclic ring, such as pyrrolidino, piperidino or morpholino.

When a plurality of sulfonic acid groups are present in the molecule, the ammonium cations may have identical or different meanings.

Examples of preferred ammonium cations are unsubstituted ammonium, a cation of formula 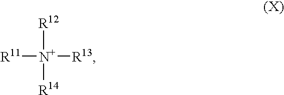
wherein R¹¹, R¹², R¹³ and R¹⁴ are each a hydrogen atom, a straight-chain or branched C₁₋₁₆alkyl radical that may be unsubstituted or substituted by one or more C₁₋₄alkoxy radicals, a hydroxy-C₁₋₈alkyl radical, especially a hydroxy-C₁₋₄alkyl radical, or a C₆₋₁₀aryl radical unsubstituted or substituted by one or more C₁₋₄alkyl radicals, C₁₋₄alkoxy radicals or hydroxy groups, especially a phenyl group substituted by a hydroxy group, at least one of the radicals R¹¹, R¹², R¹³ and R¹⁴ being other than a hydrogen atom.

The following are examples of especially preferred ammonium cations:
mono-, di- or tri-C₁₋₄alkylammonium, such as trimethyl- or triethyl-ammonium or (CH₃)₂((CH₃O)₂CHCH₂)NH⁺, 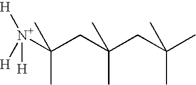
mono-, di- or tri-C₈₋₁₆alkylammonium, such as (notional representation of the ammonium cation of Primene 81R®),
mono-, di- or tri-(hydroxy-C₁₋₄alkyl)ammonium, such as mono-, di- or tri-ethanolammonium or mono-, di- or tri-isopropanolammonium or N-methyl-N-ethanol-ammonium, and 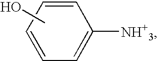
   such as 2-, 3- or 4-hydroxyphenyl.

According to the invention, a C₁₋₃₆alkyl radical is to be understood to mean a straight-chain or branched alkyl radical having from 1 to 36 carbon atoms, especially a C₁₋₆alkyl radical, which may be unsubstituted or substituted by one or more C₁₋₄alkoxy radicals, for example methyl, ethyl, n-propyl, isopropyl, n-butyl, sec-butyl, isobutyl, tert-butyl, n-pentyl, 2-pentyl, 3-pentyl, 2,2-dimethylpropyl, hexyl, heptyl, 2,4,4-trimethylpentyl, 2-ethylhexyl, octyl or dimethoxymethyl. Examples of a C₁₋₄alkoxy radical, which may be linear or branched, are methoxy, ethoxy, n-propoxy, isopropoxy, n-butoxy, sec-butoxy, isobutoxy and tert-butoxy.

The C₆₋₂₄aryl radical is preferably a C₆₋₁₂aryl radical that may be unsubstituted or substituted by C₁₋₄alkyl, C₁₋₄alkoxy or by hydroxy, for example phenyl, 4-methylphenyl, 4-methoxyphenyl or 2-, 3- or 4-hydroxyphenyl.

Examples of a C₇₋₂₄aralkyl radical, especially a C₇₋₁₂aralkyl radical, which may be unsubstituted or substituted, are benzyl, 2-benzyl-2-propyl, β-phenyl-ethyl, α,α-dimethylbenzyl, ω-phenyl-butyl and ω-phenyl-octyl.

Preferred dyes of formula II have the following structure: 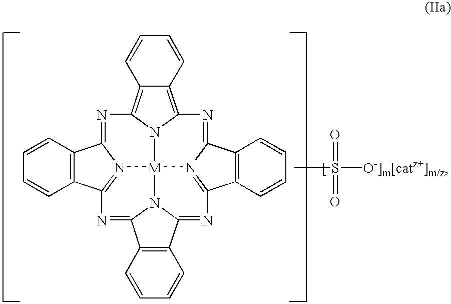
wherein M is H₂, a divalent metal selected from the group Cu(II), Zn(II), Fe(II), Ni(II), Ru(lI), Rh(II), Pd(II), Pt(II), Mn(II), Mg(II), Be(II), Ca(II), Ba(II), Cd(II), Hg(II), Sn(II), Co(II) and Pb(II), especially Cu(II) or Zn(II), or a divalent oxometal selected from the group V(O), Mn(O) and TiO, and m is a value from 3 to 5, especially from 3 to 4; 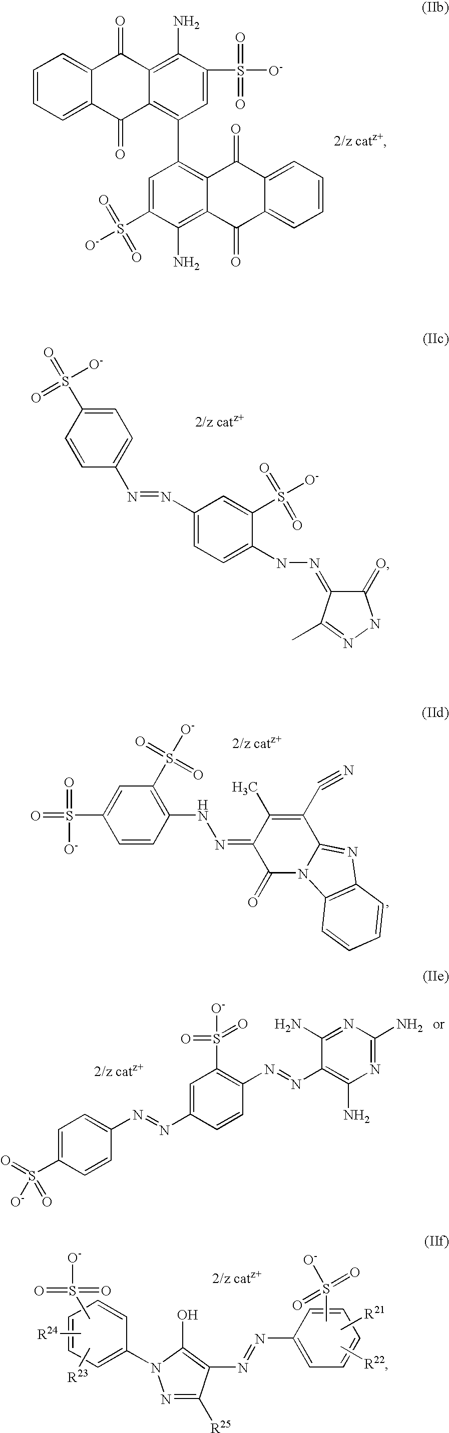
wherein R²¹ and R²² are independently of the other hydrogen, halogen, especially chlorine, a C₁₋₄alkyl radical, especially —CH₃, or —C₂H₅, a C₁₋₄alkoxy radical, especially —OCH₃, or —OC₂H₅ or the group of formula —NHCO—C₁-C₄alkyl,
R²³ and R²⁴ are each independently of the other hydrogen, halogen, especially chlorine, a C₁₋₄alkyl radical, especially —CH₃, or —C₂H₅, a C₁₋₄alkoxy radical, especially —OCH₃, or —OC₂H₅ or the group formula —NHCO—C₁-C₄akkyl, and
R²⁵ is a C₁₋₄alkyl radical, especially —CH₃, phenyl, a C₁₋₄alkoxy radical, especially —COOCH₃, —COOC₂H₅, —NHCO—C₁-C₄alkyl or —CONH-C₁-C₄alkyl, especially 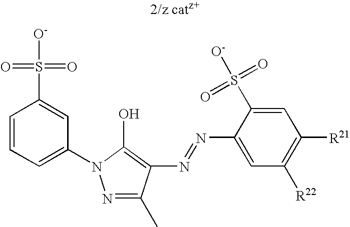
wherein R²¹ is —CH₃ and R²² is chlorine, R²¹ and R²² are chlorine, R²¹ is —CH₃ and R²² is hydrogen, or R²¹ is chlorine and R²² is —C₂H₅, cat being as defined hereinabove, especially calcium 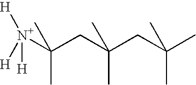
   (notional representation of the ammonium cation of Primene 81R®), mono-, di- or tri-C₁₋₂alkyl- and/or -β-hydroxy-C₂₋₃alkylammonium, for example mono-, di- or tri-isopropanolammonium, mono-, di- or tri-ethanolammonium, N-methyl-N-ethanol-ammonium (CH₃)₂((CH₃O)₂CHCH₂)NH⁺ or 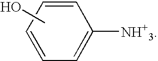
   In case of the salts of formula IIf cat is in particular calcium, or unsubstituted ammonium or a mixture of calcium and unsubstituted ammonium.

A further preferrred embodiment concerns a process for producing colored oxide layers on aluminum or on aluminum alloys by dyeing in an aqueous dye bath, rinsing with water and sealing, wherein there is used for the dyeing at least one dye of the general formula 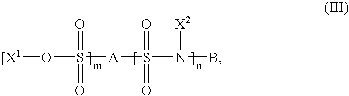
wherein m is a value from 1 to 8, especially from 1 to 4,
n is a value from 1 to 7, especially from 1 to 4, the sum of m and n being less than or equal to 8,
A is the radical of a chromophore of the 1-aminoanthraquinone, anthraquinone, anthrapyrimidine, azo, azomethine, benzodifuranone, quinacridone, quinacridonequinone, quinophthalone, diketopyrrolopyrrole, dioxazine, flavanthrone, indanthrone, indigo, isoindoline, isoindolinone, isoviolanthrone, perinone, perylene, phthalocyanine, pyranthrone or thioindigo series,
B is a hydrogen atom, a branched or straight-chain C₁₋₈alkyl, C₂₋₈alkenyl or C₂₋₈alkynyl radical, an aryl radical, an N—, O— or S-containing 5- or 6-membered heterocyclic ring, or a C₁₋₈alkyl-arylene, aryl-C₁₋₈-alkylene or aryl-L-arylene radical, each of which may be substituted by one or more groups —OH, —Ocat, —COOH, —COOcat, —SH, —Scat, —OR¹, —SR², —C(O)OR³, —C(O)R⁴, —NR⁵R⁶, wherein the C₁₋₈-alkyl radical may be uninterrupted or interrupted one or more times by —O— or by —S—,
R¹, R², R³ and R⁴ are each independently of the others a C₁₋₈alkyl radical, C₇₋₁₁aralkyl radical or C₆₋₁₀aryl radical and R⁴ additionally may be a hydrogen atom,
L is a bond, is —NR⁷ wherein R⁷ is a hydrogen atom or a C₁₋₄alkyl radical, or is a group —N═N—, and R⁵ and R⁶ are each independently of the other a hydrogen atom, a C₁₋₈alkyl radical, a C₁₋₄alkoxy-C₁₋₄alkyl radical, a C₆₋₁₀aryl radical, a C₇₋₁₁aralkyl radical or a —(CH₂)ₒOH radical
wherein o is an an integer from 2 to 6,
X¹ is a hydrogen atom or cat and
X² is a hydrogen atom or cat,
cat being a cation, and to the substrates colored by such a process.

Preferred dyes of formula III have the following structure: 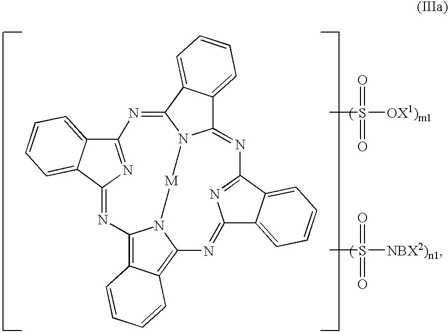
wherein M is H₂, a divalent metal selected from the group Cu(II), Zn(II), Fe(II), Ni(II), Ru(II), Rh(II), Pd(II), Pt(II), Mn(II), Mg(II), Be(II), Ca(II), Ba(II), Cd(II), Hg(II), Sn(II), Co(II) and Pb(II), especially Cu(II) or Zn(II), or a divalent oxometal selected from the group V(O), Mn(O) and TiO, m1 is a value from 1 to 4, especially from 1 to 3, and n1 is a value from 1 to 4, especially from 1 to 3, the sum of m1 and n1 preferably being from 3 to 5; 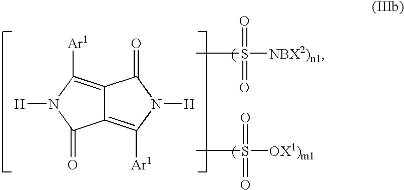
wherein Ar¹ is a group of formula 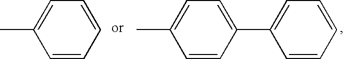
m1 is a value from 1 to 3, especially from 1 to 2, and n1 is a value from 1 to 3, especially from 1 to 2, the sum of m1 and n1 preferably being from 1 to 4; 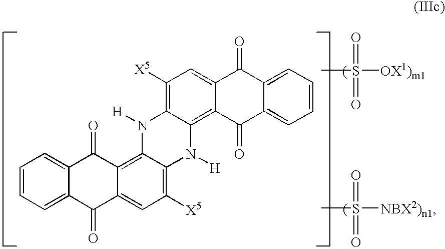
wherein X⁵ is a hydrogen or chlorine atom, ml is a value from 1 to 4, especially from 1 to 3, and n1 is a value from 1 to 4, especially from 1 to 3, the sum of m1 and n1 preferably being from 3 to 5; or 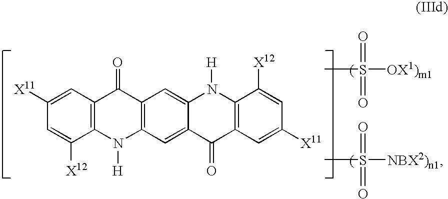
wherein X¹¹ and X¹² are each independently of the others hydrogen, a chlorine atom or a methyl group, m1 is a value from 1 to 4, especially from 1 to 3, and n1 is a value from 1 to 4, especially from 1 to 3, the sum of m1 and n1 preferably being from 2 to 4; B is a hydrogen atom, -(CH₂)e-E or 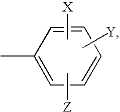
wherein e is an integer from 1 to 6, especially 2 or 3, E is a hydrogen atom or a group —OH, —Ocat, —SH, —Scat, —OR¹, —SR², —NR⁵R⁶ or —C(O)OR³, and X, Y and Z are each independently of the others selected from a hydrogen atom and the groups —OH, —Ocat, —SH, —Scat, —OR¹, —SR², —NR⁵R⁶ and —C(O)OR³ wherein R¹, R² and R³ are each independently of the others a C₁₋₄alkyl radical, especially methyl or ethyl, and R⁵ and R⁶ are a
-(CH₂)ₒOH radical wherein o is an integer from 2 to 6,
X¹ is a hydrogen atom or cat and
X² is a hydrogen atom or cat,
cat is an alkali metal cation, especially a sodium or potassium cation, calcium or unsubstituted ammonium, or an ammonium cation described hereinabove as preferred.

The compounds listed below are especially preferred:

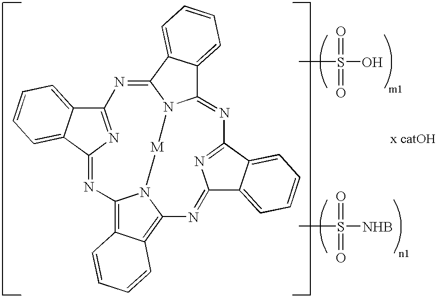

| Compound | B | M | m1 | n1 | x cat |
|---|---|---|---|---|---|
| F1 | 4-hydroxyphenyl | Cu | 3 | 1 | 3 HOCH₂CH₂NH₃⁺ |
| F2 | 4-hydroxyphenyl | Cu | 3 | 1 | 3 Na⁺ |
| F3 | 4-hydroxyphenyl | Cu | 3 | 1 | 5 Na⁺ |
| F4 | 4-hydroxyphenyl | Cu | 2 | 2 | 2 HOCH₂CH₂NH₃⁺ |
| F5 | 4-hydroxyphenyl | Cu | 2 | 2 | 2 Na⁺ |
| F6 | 4-hydroxyphenyl | Cu | 2 | 2 | 4 Na⁺ |
| F7 | 4-hydroxyphenyl | Cu | 1 | 3 | 1 HOCH₂CH₂NH₃⁺ |
| F8 | 4-hydroxyphenyl | Cu | 1 | 3 | 2 Na⁺ |
| F9 | 4-hydroxyphenyl | Cu | 1 | 3 | 4 Na⁺ |
| F10 | 3-hydroxyphenol | Cu | 3 | 1 | 3 HOCH₂CH₂NH₃⁺ |
| F11 | 3-hydroxyphenol | Cu | 3 | 1 | 2 Na⁺ |
| F12 | 3-hydroxyphenol | Cu | 3 | 1 | 3 Na⁺ |
| F13 | 3-hydroxypropyl | Cu | 3 | 1 | — |
| F14 | 3-hydroxypropyl | Cu | 2 | 2 | — |
| F15 | 3-hydroxypropyl | Cu | 1 | 3 | — |
| F16 | 3-hydroxyphenol | Zn | 1 | 3 | 4 Na⁺ |
| F17 | 3-hydroxyphenol | Zn | 1 | 3 | 7 Na⁺ |
| F18 | 3-hydroxyphenol | Zn | 2 | 2 | 4 Na⁺ |
| F19 | 3-hydroxyphenol | Zn | 2 | 2 | 6 Na⁺ |
| F20 | 3-hydroxyphenol | Zn | 2 | 2 | 6 HOCH₂CH₂NH₃⁺ |
| F21 | 3-hydroxyethyl | Zn | 3 | 1 | — |
| F22 | 3-hydroxyethyl | Zn | 2 | 2 | — |
| F23 | 3-hydroxyethyl | Zn | 1 | 3 | — |
| F24 | 3-hydroxyphenol | Cu | 1 | 3 | 4 Na⁺ |
| F25 | 3-hydroxyphenol | Cu | 1 | 3 | 7 Na⁺ |
| F26 | 3-hydroxyphenol | Cu | 2 | 2 | 7 Na⁺ |
| F27 | 3-hydroxyethyl | Cu | 3 | 1 | — |
| F28 | 3-hydroxyethyl | Cu | 2 | 2 | — |
| F29 | 3-hydroxyethyl | Cu | 1 | 3 | — |

The oxide layers to be colored are especially oxide layers synthetically produced on aluminum or on aluminum alloys.

There come into consideration as aluminum alloys mainly those in which the the proportion of aluminum is predominant, especially alloys with magnesium, silicon, zinc and/or copper, for example Al/Mg, Al/Si, Al/Mg/Si, Al/Zn/Mg, Al/Cu/Mg and Al/Zn/Mg/Cu, more especially those in which the content of aluminum is at least 90% by weight; the magnesium content is preferably ≦6% by weight; the silicon content is preferably ≦6% by weight; the zinc content is preferably ≦10% by weight and the copper content is advantageously ≦2% by weight, preferably ≦0.2% by weight.

The oxide layers formed on the metallic aluminum or on the aluminum alloys may have been produced by chemical oxidation or, preferably, by galvanic means by anodic oxidation. The anodic oxidation of the aluminum or aluminum alloy for passivation and the formation of a porous layer can be carried out according to known methods using direct current and/or alternating current and in each case using suitable electrolyte baths, for example with the addition of sulfuric acid, oxalic acid, chromic acid, citric acid or combinations of oxalic acid and chromic acid or sulfuric acid and oxalic acid. Such anodisation procedures are known in the art: DCS procedure (direct current, sulfuric acid), DCSX procedure (direct current; sulfuric acid with the addition of oxalic acid), DCX procedure (direct current; oxalic acid), DCX procedure with the addition of chromic acid, ACX procedure (alternating current; oxalic acid), ACX-DCX procedure (oxalic acid; first alternating current then direct current), ACS procedure (alternating current; sulfuric acid) and chromic acid procedure (direct current; chromic acid). The current voltages are generally in the range from 5 to 80 volts, preferably from 8 to 50 volts; the temperatures are generally in the range from 5 to 50° C.; the current density at the anode is generally in the range from 0.3 to 5 A/dm², preferably from 0.5 to 4 A/dm², current densities as low as ≦2 A/dm² generally being suitable for the production of a porous oxide layer; at higher voltages and current densities, for example in the range from 100 to 150 volts and ≧2 A/dm², especially 2 to 3 A/dm², and at temperatures up to 80° C., oxide layers that are especially hard and fine-pored can be produced, for example according to the “Ematal” process with oxalic acid in the presence of titanium and zirconium salts. For the production of oxide layers that are subsequently colored electrolytically or directly, using a dye of formula (I), by adsorptive means, the current voltage according to a preferred procedure customary per se in practice is in the range from 12 to 20 volts; the current density in that procedure is preferably from 1 to 2 A/dm². Such anodisation procedures are generally known in the art and described in detail in the specialised literature, e.g. in Ullmann's “Enzyklopädie der Technischen Chemie”, 4th edition, volume 12, pages 196 to 198, or in the Sandoz brochures “Sanodale” (Sandoz AG, Basle, Switzerland, Publication No. 9083.00.89) or “Ratgeber für das Adsorptive Färben von Anodisiertem Aluminum” (Sandoz, Publications No. 9122.00.80). The thickness of the porous oxide layer is advantageously in the range from 5 to 35 μm, especially from 15 to 30 μm, more especially from 15 to 25 μm.

To color the oxide layer using the dyes of formula I, it is possible to use dyeing methods that are customary per se, especially adsorption methods (essentially without electric current), in which the dye solution is applied to the oxide surface, for example, by spraying or by application with a roller (depending on the shape of the substrate) or, preferably, by immersion in a dye bath of the article to be colored.

The dyeing is expediently carried out at temperatures below the boiling point of the liquor, advantageously at temperatures in the range from 15 to 80° C., especially in the range from 15 to 70° C., more especially in the range from 20 to 60° C. The pH value of the dye liquor is in the acidic to weakly basic range, generally in the pH range from 3 to 8, with preference being given to weakly acidic to almost neutral conditions, especially a pH range from 4 to 6. The concentration of dye and the duration of the dyeing procedure may vary very widely depending on the subtrate and the desired coloration effect. Suitable dye concentrations are in the range from 0.01 to 20 g/l, advantageously from 0.1 to 10 g/l, especially from 0.2 to 2 g/l. The duration of the dyeing procedure is generally in the range from 30 seconds to 1 hour and is preferably from 5 to 40 minutes.

The dyeings obtained in that manner can be hot-sealed and/or cold-sealed according to customary methods, where appropriate with the use of suitable additives, the dyeings advantageously being rinsed with water before sealing.

For example, sealing can be carried out in one or two steps at pH values of from 4.5 to 8 using metal salts or metal oxides (e.g. nickel acetate or cobalt acetate) or using chromates. Sealing can also, as described DE-A-3 327 191, be carried out using organic sealing agents, such as, for example, organic phosphonates and diphosphonates or also water-soluble (cyclo)aliphatic polycarboxylic acids or aromatic ortho-hydroxycarboxylic acids at pH values in the range from 4.5 to 8.

There may be used for the cold-sealing especially nickel salts or cobalt salts in combination with alkali metal fluorides, such as NaF. According to the invention, cold-sealing can, for example, be carried out using a sealing agent containing nickel ions Ni²⁺ and fluoride ions F⁻, as described in EP-A-1 087 038. Sealing auxiliaries determined, for example, by the subtrate and/or dye, for example cobalt compounds, may optionally be present in small amounts of up to 10% by weight in the sealing agents. The sealing agents may be used with further auxiliaries, such as (anionic) surfactants, especially sulfo-group-containing surfactants, preferably condensation products of sulfo-group-containing aromatic compounds with formaldehyde, for example condensation products of sulfonated naphthalene or/and sulfonated phenols with formaldehyde to form oligomeric condensation products having a surfactant nature, and/or anti-deposit additives (see, for example, DE-A-3 900 169 or DE-C-3 327 191), which comprise, for example, salts of organic acids and non-ionic surfactants, for example P3-almeco seal® 1 (Henkel). The cold-sealing is generally carried out at temperatures below 45° C., especially in the range from 18 to 40° C., more especially from 20 to 40° C. The Ni²⁺ concentration in the sealing bath is advantageously in the range from 0.05 to 10 g/l, especially in the range from 0.1 to 5 g/l. The pH value of the sealing bath is, for example, in the acidic to weakly basic range, advantageously in the pH range from 4.5 to 8. The duration of the sealing procedure depends on the thickness of the layer and is, for example, from 0.4 to 2 minutes, preferably from 0.6 to 1.2 minutes, per μm of thickness of the oxide layer of the substrate, sealing advantageously being carried out for from 5 to 60 minutes, preferably from 10 to 30 minutes. Sealing times of from 10 to 30 minutes are suitable for the preferred oxide layers having a thickness of at least 15 μm, preferably from 15 to 30 μm, that are suitable especially for external architectural components.

The hot-treatment with water is advantageously carried out in a temperature range from 80° C. to boiling temperature, preferably at from 90 to 100° C. or alternatively with steam at temperatures from 95 to 1 50° C. optionally under pressure, for example at an elevated pressure in the range from 1 to 4 bar. The duration of the after-sealing with water is generally in the range from 15 to 60 minutes.

It may be advantageous to carry out a two-step sealing procedure in which, in a first step, cold-sealing is effected in deionised water using at least one sealing agent, such as nickel acetate, optionally in the presence of an anti-deposit (anti-smut) agent, such as P3-almecoseal® 1 (Henkel) and, in a second step, hot after-sealing is effected in deionised water optionally in the presence of an anti-deposit agent, such as P3-almecoseal® 1 (Henkel). It has been demonstrated that very good results can be obtained especially when aluminum and calcium salts, such as AlCl₃.6H₂O, aluminum acetate or calcium chloride, are used as a substitute for the toxic nickel salts. Samples sealed with such salts in addition exhibit a lower tendency to release the dye from the pores.

The present invention accordingly relates also to a process for producing colored oxide layers on aluminum or on aluminum alloys by dyeing in an aqueous dye bath, rinsing with water and sealing, which process comprises carrying out the cold- and/or hot-sealing in the presence of aluminum salts, especially AlCl₃.6 H₂O or aluminum acetate, or calcium salts, especially CaCl₂.

There is especially used a two-step sealing procedure in which, in a first step, cold-sealing is carried out in deionised water at about 40° C. for from 5 to 60 minutes, preferably from 10 to 30 minutes, using from 0.1 to 5 g/l, especially from 1.5 to 2.5 g/l, of nickel acetate in the presence of from 1 to 3 g/l of an anti-deposit agent, such as P3-almecoseal® 1 (Henkel) and, in a second step, hot after-sealing is carried out in boiling deionised water for from 15 to 60 minutes, especially from 30 to 45 minutes.

The treatment of the aluminum substrates with a strong inorganic or organic acid, such as nitric acid, hydrochloric acid, phosphoric acid, haloacetic acids or p-toluenesulfonic acids, after dyeing and before sealing, may result in an increase in the light fastness of the colored aluminum substrates.

Compared with commercially available dyes and dyes of formula I in which cat⁺ is an alkali metal, the dyeings obtainable according to the process of the invention have surprisingly high light-fastness properties, it being possible for the ΔE of the dyeings after 240 hours' irradiation, especially after 480 hours' irradiation, to be less than 6.

In particular, the compounds of formula II wherein M is Cu²⁺ and compounds of formula III exhibit excellent light-fastness properties, ΔE after 240 hours being less than 3 and after 480 hours less than 5.

A further embodiment of the present invention relates to colored aluminum pigments that comprise platelet-like aluminum substrates coated with a metal oxide layer, wherein the metal oxide layer comprises dyes of formula I and the metals of the metal layer are selected from vanadium, titanium, zirconium, silicon, aluminum and boron.

Further layers that can be produced according to customary chemical processes or by vapour deposition may be present in addition to the metal oxide layer. Customary materials for further layers include, for example, metals, such as Ag, Al, Au, Cu, Co, Cr, Fe, Ge, Mo, Nb, Ni, Si, Ti, V, alloys thereof, inorganic or organic pigments or colourants, graphite and graphite-like compounds, which are disclosed, for example, in EP 0 982 376. The further layers may furthermore be composed of metal oxides, such as MoS₂, TiO₂, ZrO₂, SiO, SiO₂, SnO₂, GeO₂, ZnO, Al₂O₃, V₂O₅, Fe₂O₃, Cr₂O₃, PbTiO₃ or CuO and mixtures thereof, or the further layers may alternatively consist of known dielectric materials of which the specific electrical resistance according to the conventional definition is at least 10¹⁰ Ω.cm.

The ratio of thickness to diameter of the platelets is quoted as a physical parameter and is generally from 1:50 to 1:500. The particles are generally from 2 μm to 5 mm long, preferably from 5 μm to 50 μm long, from 2 μm to 2 mm wide, preferably from 5 μm to 20 μm wide, and from 50 nm to 3.0 μm thick, preferably from 1 μm to 20 μm thick. Depending on the production process, they have a more or less statistical particle size distribution having a d₅₀ of from 5 to 50 μm.

The amount of dye is generally from 5 to 40% by weight and the amount of metal oxide from 3 to 95% by weight, each based on the aluminum substrate.

The aluminum pigments are obtainable analogously to a process described in DE-A-195 01 307 by producing the metal oxide layer by means of a sol-gel process by controlled hydroysis of one or more metallic acid esters in the presence of one or more of the dyes according to the invention and, optionally, an organic solvent and, optionally, a basic catalyst.

Suitable basic catalysts are, for example, amines, such as triethylamine, ethylenediamine, tributylamine, dimethylethanolamine or methoxypropylamine.

Suitable aluminum pigments include any customary aluminum pigments that can be used for decorative coatings and also the oxidised colored aluminum pigments described in DE-A-1 95 20 312. Preference is given to the use of round aluminum platelets (so-called silver dollars).

The organic solvent is a water-miscible organic solvent, such as a C₁₋₄alcohol, especially isopropanol.

Suitable metallic acid esters are from the group comprising alkyl and aryl alcoholates, carboxylates, and alkyl alcoholates or carboxylates that have been substituted by carboxy radicals or alkyl radicals or aryl radicals, of vanadium, titanium, zirconium, silicon, aluminum and boron. Preference is given to the use of triisopropyl aluminate, tetraisopropyl titanate, tetraisopropyl zirconate, tetraethyl orthosilicate and triethyl borate. It is also possible to use acetylacetonates and acetoacetylacetonates of the above-mentioned metals. Preferred examples of that type of metallic acid ester are zirconium, aluminum or titanium acetyl-acetonate and diisobutyloleyl acetoacetylaluminate or diisopropyloleyl acetoacetylacetonate and mixtures of metallic acid esters, for example Dynasil® (Hüls), a mixed silicon/silicon metallic acid ester.

The aluminum pigment can furthermore be prepared analogously to a process described in EP-A-0 380 073. A layer of an anodically oxidisable metal having a thickness corresponding to at least 500 nm is applied to a carrier that has optionally been coated with a separating agent, and is anodically oxidised in an electrolyte at a voltage of from 0.5 to 100 V. The porous metal oxide layer is then colored using the dyes according to the invention and sealed. The separating agent is subsequently dissolved in a suitable solvent, the aluminum pigment being obtained in the form of coarse flakes, which can be further processed by removal of the solvent, drying and grinding (see, for example, WO 00/18978, WO 01/25500 and WO 01/57287).

The carrier coated with an anodically oxidisable metal is obtainable according to processes known per se. Advantageously, carriers to which a thin metal layer has been applied by sputtering or by chemical methods or vapour-deposited by means of vacuum technology are used. The layer thickness of the metal is advantageously so selected that the metal layer remaining after anodic oxidation is covered with a metal oxide layer at least 10 nm thick, preferably at least 100 nm thick. The layer thickness of the metal is generally from 500 nm to 5 μm, preferably from 1 μm to 2 μm.

Suitable electrolytes are known and are described e.g. in J. Electrochem. Soc.: Electrochemical Science and Technology, 122,1, page 32 (1975). Dilute aqueous solutions (e.g. up to 20% by weight) of inorganic acids or carboxylic acids (sulfuric acid, phosphoric acid, chromic acid, formic acid, oxalic acid), of alkali metal salts of inorganic acids or carboxylic acids (sodium sulfate, sodium bisulfate, sodium formate) and alkali metal hydroxides (KOH, NaOH), for example, are suitable.

The anodic oxidation can be carried out at a temperature of from 0 to 60° C and preferably at room temperature. The voltage to be selected depends largely on the electrolyte used and is generally from 0.5 to 100 V. Electrolysis can be carried out with alternating current and preferably with direct current.

The carrier has a surface of metal, glass, enamel, ceramics or an organic material and may be of any shape, sheets, films and plates being preferred. The carrier may be, for example, glass, a mineral (quartz, sapphire, ruby, beryllium or silicate), a ceramic material, silicon or a plastics (cellulose, polymethacrylate, polycarbonate, polyester, polyolefin, polystyrene).

The separating agents may be inorganic separating agents, such as separating agents vaporisable in vacuo, for example chlorides, borates, fluorides and hydroxides and further inorganic substances, which are described, for example, in U.S. Pat. No. 5,156,720 and U.S. Pat. No. 3,123,489, or organic separating agents, such as lacquers, sodium stearate, lithium stearate, magnesium stearate, aluminum stearate, fatty alcohols and wax alcohols of the type CₓH_{y}O wherein 15<C<30, paraffin waxes, branched and unbranched fatty acids wherein C>15 and thermoplastics.

The metal layer is formed from aluminum itself or from an alloy of aluminum with, e.g., Mg or Zn. A preferred lower value for the layer thickness is 500 nm. The upper value for the layer thickness is a maximum of 5.0 μm. The thickness is especially from 0.5 to 3.0 μm and more especially from 1.0 to 2.0 μm.

The thickness of the oxide layer depends largely on the starting thickness of the metal layer.

The oxide layer may be, for example, from 10 nm to 500 nm thick. Layer thickness ranges from 100 nm to 500 nm are preferred.

The diameter of the pores in the metal oxide layer depends largely on the production conditions for the electrolysis, especially on the electrolyte used. The diameter may be, for example, from 2 nm to 500 nm.

The aluminum pigments according to the invention can be used to give effects in surface coatings, coatings, plastics, printing inks and cosmetic preparations.

The following Examples illustrate the present invention but do not represent a limitation of the scope of the present invention. In the Examples, unless indicated otherwise, parts are parts by weight and percentages are percentages by weight.

The light fastness is ascertained by dry exposure of a sample in light exposure cycles in an Atlas-Weather-O-meter Ci 65 A equipped with a xenon arc lamp. For the comparison, the color shade, the tinctorial strength and the brightness of the exposed samples are measured using a spectrophotometer from X-ride model SP 68 (10° standard observer; standard illuminant D₆₅; color temperature: 6774 K). The resulting color difference ΔE in the L*a*b*-color space (CIELAB color system) is listed in the Tables hereinbelow.

### Synthesis Example 1

60.0 g of 4,4′-diamino-1,1′-bisanthraquinone-3,3′-sodium sulfonate (V-1) in 300.0 g of hydrochloric acid (technical grade/32%) are introduced into a sulfonating flask (750 ml). The red suspension is heated to from 65 to 70° C. After 3 hours at 65° C., the red suspension is allowed to cool to room temperature and, in the course of 15 minutes, added to a mixture of 120.0 g of water and 1400.0 g of ice. The resulting violet suspension is filtered through a suction filter and washed with 120.0 g of ice-water. The moist violet filter cake is added in portions to a solution of 11.3 g of ethanolamine in 1800 g of water. The resulting mixture is heated at 100° C. for 1 hour and then filtered at 50° C through a suction filter and washed with 200.0 g of water. After concentration by evaporation of the dark-red solution and drying, 65 g (97% yield) of A-1 are obtained in the form of a dark-red powder.

### Synthesis Examples 2 and 3

The compounds A-2 and A-3 are prepared from V-1 analogously to Synthesis Example 1.

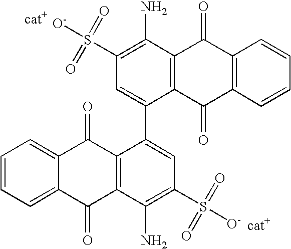

| Compound | cat⁺ | Synthesis Example |
|---|---|---|
| A-1 | HOCH₂CH₂NH₃⁺ | 1 |
| A-2 | (HOCH₂CH₂)₂NH₂⁺ | 2 |
| A-3 | (HOCH₂CH₂)₃NH⁺ | 3 |
| V-1 | Na⁺ | — |

### Application Example 1

A degreased and deoxidised sheet of pure aluminum is anodically oxidised for from 30 to 40 minutes at a voltage of from 15 to 16 volts, using a direct current having a density of 1.5 A/dm², at a temperature of from 18 to 20° C., in an aqueous solution containing, per 100 parts, 18-22 parts of sulfuric acid and 1.2-7.5 parts of aluminum sulfate. An oxide layer approximately 18-20 μm thick having a porosity of 17% is formed. After rinsing with water, the anodised aluminum sheet is dyed for 40 minutes at 60° C. in a solution consisting of 0.5 part of the dye of formula I per 100 parts of deionised water, the pH of which has been adjusted to 5.5 using acetic acid and sodium acetate.

The Alox layer is then sealed for 20 minutes at 40° C. in a solution of 2 g/l of nickel acetate and 2 g/l of P3-Almeco Seal® (Henkel) in deionised water and subsequently after-sealed for 40 minutes in boiling deionised water. The samples are then exposed to light in an Atlas-Weather-O-meter Ci 65 A.

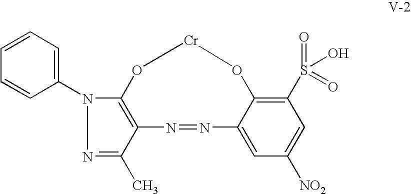

The following Table 1 shows a comparison of the light-fastness properties of aluminum sheets colored using the compounds A-1, A-2 and A-3 according to the invention and using the comparison compounds V-1 and V-2.

TABLE 1

| | | | | | | |
|---|---|---|---|---|---|---|
| Compound | 25 h | 120 h | 240 h | 360 h | 480 h | 600 h |

| | | | | | | |
|---|---|---|---|---|---|---|
| V-2 | 8 | 40 | | | | |
| V-1 | 2.7 | 5.9 | 7.8 | 9.9 | 11.2 | 11.8 |
| A-1 | 0.6 | 1.8 | 2.9 | 3.5 | 3.6 | 4.3 |
| A-2 | 0.4 | 1.2 | 1.8 | 2.3 | 2.5 | 3.1 |
| A-3 | 0.3 | 1 | 1.8 | 2.1 | 2.2 | 2.7 |

### Synthesis Examples 4 to 10

Compounds B-1 to B-3 and C-1 to C-4 are prepared analogously to Synthesis Example 1.

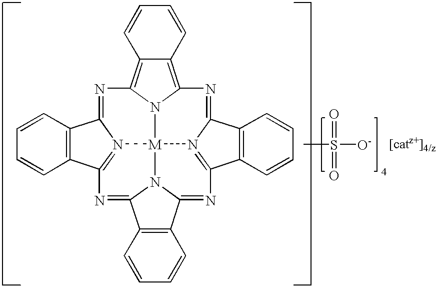

| Compound | M | cat⁺ | Synthesis Example |
|---|---|---|---|
| B-1 | Zn²⁺ | HOCH₂CH₂NH₃⁺ | 4 |
| B-2 | Zn²⁺ | NH₄⁺ | 5 |
| B-3 | Zn²⁺ | (CH₃)₃NH⁺ | 6 |
| V-3 | Zn²⁺ | Na⁺ | — |
| C-1 | Cu²⁺ | HOCH₂CH₂NH₃⁺ | 7 |
| C-2 | Cu²⁺ | NH₄⁺ | 8 |
| C-3 | Cu²⁺ | (CH₃)₃NH⁺ | 9 |
| C-4 | Cu²⁺ | (CH₃)₂((CH₃O)₂CHCH₂)NH⁺ | 10 |
| V-4 | Cu²⁺ | Na⁺ | — |

The following Table 2 shows a comparison of the light-fastness properties of aluminum sheets colored using the compounds B-1, B-2 and B-3 according to the invention and using the comparison compound V-3.

TABLE 2

| Compound | 50 h | 240 h | 480 h | 720 h |
|---|---|---|---|---|
| V-3 | 6.1 | 12 | 15.2 | |
| B-1 | 3.5 | 5.9 | 7.5 | 8.8 |
| B-2 | 3.5 | 5.6 | 7 | 8 |
| B-3 | 4.4 | 8 | 10.2 | 11.9 |

The following Table 3 shows a comparison of the light-fastness properties of aluminum sheets colored using the compounds C-1, C-2, C-3 and C-4 according to the invention and using the comparison compound V-4.

TABLE 3

| Compound | 50 h | 240 h | 480 h | 720 h |
|---|---|---|---|---|
| V-4 | 1.3 | 2.9 | 5 | 6.2 |
| C-1 | 1.4 | 2.7 | 4.5 | 5.7 |
| C-2 | 1.3 | 2.1 | 3.7 | 4.4 |
| C-3 | 1.2 | 2.2 | 3.8 | 4.6 |
| C-4 | 0.6 | 2 | 3.6 | 4.4 |

### Synthesis Example 11

Compound D-1 is prepared analogously to Synthesis Example 1.

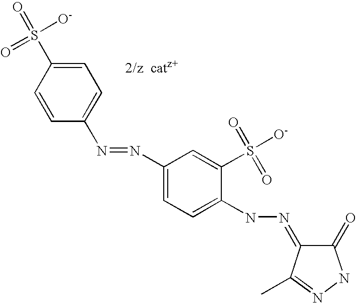

| Compound | cat⁺ | Synthesis Example |
|---|---|---|
| D-1 | HOCH₂CH₂NH₃⁺ | 11 |
| V-5 | Na⁺ | — |

| | |
|---|---|
| | (V-6) |
| 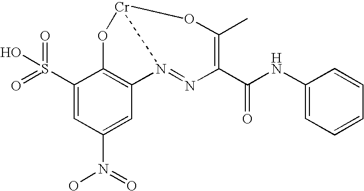 | |

The following Table 4 shows a comparison of the light-fastness properties of aluminum sheets colored using the compound D-1 according to the invention and using the comparison compounds V-5 and V-6.

TABLE 4

| Compound | 25 h | 120 h | 240 h |
|---|---|---|---|
| V-6 | 4.3 | 40.6 | |
| V-5 | 2.1 | 6.3 | 8.1 |
| D-1 | 1.2 | 4 | 4.8 |

### Synthesis Examples 12 to 14

Compounds E-1 to E-3 are prepared analogously to Synthesis Example 1.

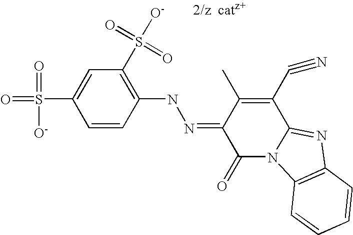

| Compound | cat⁺ | Synthesis Example |
|---|---|---|
| E-1 | HOCH₂CH₂NH₃⁺ | 12 |
| E-2 | NH₄⁺ | 13 |
| E-3 | Primene 81R® -salt¹⁾ | 14 |
| V-8 | Na⁺ | — |

¹⁾The following is a notional representation of the ammonium salt of
Primene 81R® (Rohm & Haas Company, mixture of isomeric
C₁₂₋₁₄ amines):

| | |
|---|---|
| 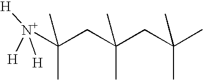 | |
| | (V-7) |
| 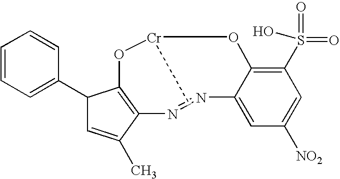 | |

The following Table 5 shows a comparison of the light-fastnes properties of aluminum sheets colored using the compounds E-1, E-2 and E-3 according to the invention and using the comparison compounds V-7 and V-8.

TABLE 5

| Compound | 50 h | 240 h |
|---|---|---|
| V-7 | 20.5 | |
| V-8 | 3.5 | 13.2 |
| E-1 | 3.4 | 17.2 |
| E-2 | 10.8 | 26.3 |
| E-3 | 3.1 | 8.5 |

### Synthesis Example 15

78.0 g of chlorosulfonic acid are introduced into a 750 ml sulfonating flask and, in the course of 15 minutes, 15.0 g of copper phthalocyanine are added in portions. Stirring is then carried out for 3 hours at 125° C. After cooling the reaction solution to 80° C., 32.8 g of thionyl chloride are added dropwise in the course of 20 minutes and the reaction solution is stirred for 3 hours at that temperature. The green solution (acid chloride) is cooled to room temperature and, with vigorous stirring, added in the course of 10 minutes to a mixture of 660.0 g of ice and 86.0 g of water. The reaction solution is filtered and washed with 300.0 g of ice-water, a blue, water-moist product being obtained. The water-moist product is introduced in portions at 0C into a solution of 2.9 g of 3-aminophenol in 10.0 g of water and 12.9 g of methanol and the resulting solution is stirred for 1 hour. After heating to room temperature, the pH value is adjusted to 7.5 using sodium hydroxide solution (32%) and the solution is refluxed at 100° C. for 3 hours while controlling the pH, a total of 17.4 g of 32% sodium hydroxide solution being added. At 45° C., 1.9 g of hydrochloric acid (32%) are subsequently added dropwise, and the reaction solution is filtered after cooling and washed with 40.0 g of water. After drying, 25.4 g of a blue powder are obtained (yield: 99%), which is reacted with 3 equivalents of ethanolammonium hydroxide, 2 equivalents of sodium hydroxide and 3 equivalents of sodium hydroxide to yield the compounds F10, F 11 and F12, respectively.

The compounds F1 to F9 and F13 to F29 listed in the following are prepared analogously to Synthesis Example 15:

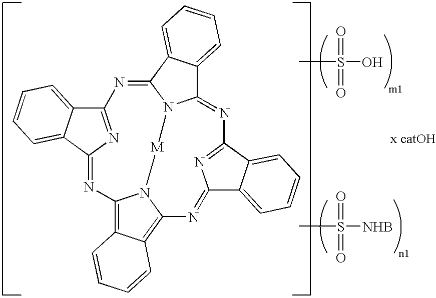

| Compound | B | M | m1 | n1 | x cat |
|---|---|---|---|---|---|
| F1 | 4-hydroxyphenyl | Cu | 3 | 1 | 3 HOCH₂CH₂NH₃⁺ |
| F2 | 4-hydroxyphenyl | Cu | 3 | 1 | 3 Na⁺ |
| F3 | 4-hydroxyphenyl | Cu | 3 | 1 | 5 Na⁺ |
| F4 | 4-hydroxyphenyl | Cu | 2 | 2 | 2 HOCH₂CH₂NH₃⁺ |
| F5 | 4-hydroxyphenyl | Cu | 2 | 2 | 2 Na⁺ |
| F6 | 4-hydroxyphenyl | Cu | 2 | 2 | 4 Na⁺ |
| F7 | 4-hydroxyphenyl | Cu | 1 | 3 | 1 HOCH₂CH₂NH₃⁺ |
| F8 | 4-hydroxyphenyl | Cu | 1 | 3 | 2 Na⁺ |
| F9 | 4-hydroxyphenyl | Cu | 1 | 3 | 4 Na⁺ |
| F10 | 3-hydroxyphenol | Cu | 3 | 1 | 3 HOCH₂CH₂NH₃⁺ |
| F11 | 3-hydroxyphenol | Cu | 3 | 1 | 2 Na⁺ |
| F12 | 3-hydroxyphenol | Cu | 3 | 1 | 3 Na⁺ |
| F13 | 3-hydroxypropyl | Cu | 3 | 1 | — |
| F14 | 3-hydroxypropyl | Cu | 2 | 2 | — |
| F15 | 3-hydroxypropyl | Cu | 1 | 3 | — |
| F16 | 3-hydroxyphenol | Zn | 1 | 3 | 4 Na⁺ |
| F17 | 3-hydroxyphenol | Zn | 1 | 3 | 7 Na⁺ |
| F18 | 3-hydroxyphenol | Zn | 2 | 2 | 4 Na⁺ |
| F19 | 3-hydroxyphenol | Zn | 2 | 2 | 6 Na⁺ |
| F20 | 3-hydroxyphenol | Zn | 2 | 2 | 6 HOCH₂CH₂NH₃⁺ |
| F21 | 3-hydroxyethyl | Zn | 3 | 1 | — |
| F22 | 3-hydroxyethyl | Zn | 2 | 2 | — |
| F23 | 3-hydroxyethyl | Zn | 1 | 3 | — |
| F24 | 3-hydroxyphenol | Cu | 1 | 3 | 4 Na⁺ |
| F25 | 3-hydroxyphenol | Cu | 1 | 3 | 7 Na⁺ |
| F26 | 3-hydroxyphenol | Cu | 2 | 2 | 7 Na⁺ |
| F27 | 3-hydroxyethyl | Cu | 3 | 1 | — |
| F28 | 3-hydroxyethyl | Cu | 2 | 2 | — |
| F29 | 3-hydroxyethyl | Cu | 1 | 3 | — |

### Synthesis Examples 45 and 46

The disulfonic acid salts G1 and G2 are obtained from the disulfonic acid compounds G1′ and G2′, respectively, by reaction with soluble calcium salts, such as calcium nitrate or calcium chloride.

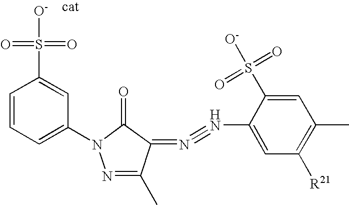

| Compound | cat | R²¹ |
|---|---|---|
| G-1′ | 2 H⁺ | H |
| G-1 | Ca²⁺ | H |
| G-2′ | 2 H⁺ | CH₃ |
| G-2 | Ca²⁺ | CH₃ |

The following Table 6 shows the light-fastness properties after 240 hours, 480 hours and 800 hours of aluminum sheets colored according to Application Example 1 using the compounds G-1 and G-2 according to the invention.

TABLE 6

| Compound | 240 h | 480 h | 600 h | 800 h | 1000 h |
|---|---|---|---|---|---|
| G-1 | 2.2 | 5.3 | 7.2 | 11.2 | 15.8 |
| G-2 | 2.7 | 7.1 | | 13.9 | |

### Application Example 2

A degreased and deoxidised sheet of pure aluminum is anodically oxidised for from 30 to 40 minutes at a voltage of from 15 to 16 volts, using a direct current having a density of 1.5 Adm², at a temperature of from 18 to 20° C., in an aqueous solution containing, per 100 parts, 18-22 parts of sulfuric acid and 1.2-7.5 parts of aluminum sulfate. An oxide layer approximately 18-20 μm thick having a porosity of 17% is formed. After rinsing with water, the anodised aluminum sheets are dyed for 15 minutes at 50° C. using 0.5% dye mixtures (see Table 7), each of which is prepared with 0.05% Invadin LUN in water and buffered to pH 6 using ammonium acetate. The aluminum sheets are optionally immersed for 10 minutes at room temperature in 20% HNO₃ prior to the actual sealing (see Table 7). Sealing is then carried out first of all for 20 minutes using a solution of 2.6 g/l of P3 Almeco Seal® and 2 g/l of nickel acetate at 40° C., and then for 20 minutes using a solution of 2.6 g/l of P3 Almeco Seal® at 98° C. The color shade of the colored aluminum sheets and the Δ E after 2000 hours are indicated in Table 7.

TABLE 7

| | Treatment | | ΔE after |
|---|---|---|---|
| Dye mixture | with HNO₃ | Color shade | 2000 h |
| 50% A1/50% C1 | no | blueish grey | 9.0 |
| 50% A1/50% C1 | yes | dark blueish grey | 1.1 |
| 50% C1/50% D1 | no | green | 15.1 |
| 50% A1/50% D1 | no | orange | 23.8 |
| 50% A1/50% D1 | yes | reddish orange | 6.6 |
| 33% A1/33% C1/33% D1 | no | dark greenish grey | 9.1 |
| 33% A1/33% C1/33% D1 | yes | dark brownish green | 4.5 |

Homogeneous dyeings are obtained. The aluminum sheets treated with HNO₃ prior to the actual sealing procedure exhibit better light-fastness properties.

### Application Example 3

As in Application Example 2, aluminum sheets are colored using a 0.5% dye mixture of compound D1 except that, instead of nickel acetate, the salts indicated in Table 8 are used and, where indicated, the dyeing time is 30 minutes instead of 15 minutes.

TABLE 8

| Salt | ΔE, 360 h | Dyeing time [minutes] |
|---|---|---|
| nickel acetate | 27.1 | 15 |
| AlCl₃.6H₂0 | 12.9 | 15 |
| CaCl₂ | 19.2 | 15 |
| nickel acetate | 25.0 | 30 |
| AlCl₃.6H₂0 | 11.6 | 30 |
| CaCl₂ | 16.9 | 30 |

The results listed in Table 8 show that, especially when aluminum salts are used as a substitute for the toxic nickel compounds, very good results can be obtained. Samples sealed in the presence of aluminum and calcium salts in addition exhibit a lower tendency to release the dye from the layers.

### Synthesis Example 47

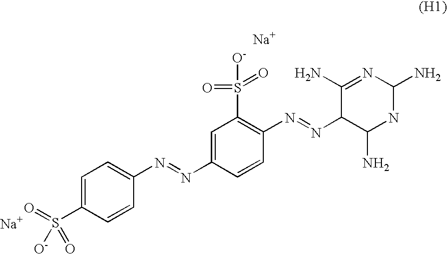

19.97 g (0.05 mol) of 4-amino-azobenzene-3,4′-disulfonic acid (Aldrich) are dissolved at 50° C in 300 ml of deionised water. The solution is cooled to 5° C. and then 6 ml of concentrated hydrochloric acid and subsequently 12.5 ml (0.05 mol) of sodium nitrite solution (4M) are added. The mixture is stirred for 30 minutes at 5° C. Aminosulfonic acid is then added until a test with iodized starch paper is negative. The pH value is then adjusted to 5.5 using sodium hydrogen carbonate and subsequently a solution prepared from 6.38 g (0.05 mol) of 1,3,5-triamino-2,4-pyrimidine (Fluka) in 200 ml of deionised water at pH 5.5 is added in the course of 30 minutes. After 1 hour, the mixture is slowly heated to 30° C. until, after a further hour, no more diazonium salt can be detected. The red suspension is filtered off with suction and dried overnight at 600° C. under 100 hPa. 25.7 g (96%) of orangeish-red product H1 are obtained.

1. A process for producing a colored oxide layer on aluminum or on an aluminum alloy by dyeing in an aqueous dyeing bath, rinsing with water and sealing, wherein there is used for the dyeing at least one dye of the general formula 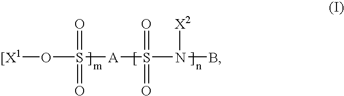
wherein m is a value from 1 to 8,
n is a value from 0 to 7, the sum of m and n being less than or equal to 8,
A is the radical of a chromophore selected from the group consisting of the 1-aminoanthraquinone, anthraquinone, anthrapyrimidine, azo, azomethine, benzodifuranone, quinacridone, quinacridonequinone, quinophthalone, diketopyrrolopyrrole, dioxazine, flavanthrone, indanthrone, indigo, isoindoline, isoindolinone, isoviolanthrone, perinone, perylene, phthalocyanine, pyranthrone and thioindigo series,
B is a hydrogen atom, a branched or straight-chain C₁₋₈alkyl, C₂₋₈alkenyl or C₂₋₈alkynyl radical, an aryl radical, an N—, O— or S-containing 5- or 6-membered heterocyclic ring, or a C₁₋₈alkylarylene, aryl-C₁₋₈alkylene or aryl-L-arylene radical, each of which may be substituted by one or more groups —OH, —Ocat, —COOH, —COOcat, —SH, —Scat, —OR¹, —SR², —C(O)OR³, —C(O)R⁴, —NR⁵R⁶, it being possible for the C₁₋₈alkyl radical to be uninterrupted or interrupted one or more times by —O— or by —S—,
R¹, R², R³ and R⁴ are each independently of the others a C₁₋₈alkyl radical, C₇₋₁₁aralkyl radical or C₆₋₁₀aryl radical and R⁴ additionally may be a hydrogen atom,
L is a bond, is —NR⁷ wherein R⁷ is a hydrogen atom or a C₁₋₄alkyl radical, or is a —N═N-group, and R⁵ and R⁶ are each independently of the other a hydrogen atom, a C₁₋₈alkyl radical, a C₁₋₄alkoxy-C₁₋₄alkyl radical, a C₆₋₁₀aryl radical, a C₇₋₁₁aralkyl radical or a —(CH₂)ₒOH radical wherein o is an integer from 2 to 6,
X¹ is a hydrogen atom or cat and
X² is a hydrogen atom or cat,
cat being a cation.

2. A process according to claim 1, wherein there is used for the dyeing at least one dye of the general formula 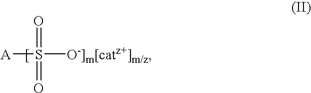
wherein m is a value from 1 to 8,
A is as defined in claim 1 and
cat is an ammonium cation or an alkaline earth metal cation.

3. A process according to claim 2, wherein the dye of formula II has the following structure 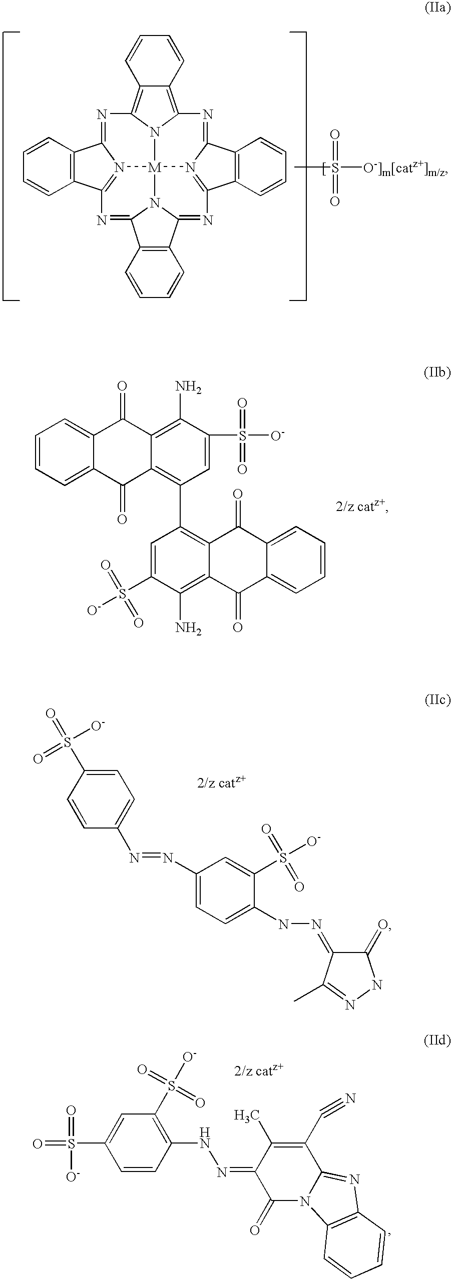 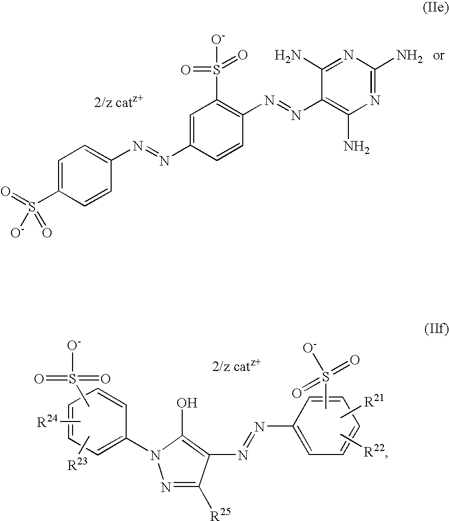
wherein R²¹ and R²² are independently of the other hydrogen, chlorine or other halogen, a C₁₋₄alkyl radical, a C₁₋₄alkoxy radical, or the group of formula —NHCO-C₁-C₄alkyl, R²³ and R²⁴ are each independently of the other hydrogen, chlorine or other halogen, a C₁₋₄alkyl radical, a C₁₋₄alkoxy radical, or —OC₂H₅ or the group of formula —NHCO-C₁-C₄alkyl, and
R²⁵ is a C₁₋₄alkyl radical, phenyl, a C₁₋₄alkoxy radical, —COOCH₃, —COOC₂H₅, NHCO-C₁-C₄alkyl or —CONH-C₁₋₄alkyl, cat being as defined in claim 2, M is H₂, a divalent metal selected from the group Cu(II), Zn(II), Fe(II), Ni(II), Ru(II), Rh(II), Pd(II), Pt(II), Mn(II), Mg(II), Be(II), Ca(II), Ba(II), Cd(II), Hg(II), Sn(II), Co(II) and Pb(II) or a divalent oxometal selected from the group V(O), Mn(O) and TiO, and m is a value from 3 to 5.

4. A process according to claim 2, wherein the dye of formula II has the following structure 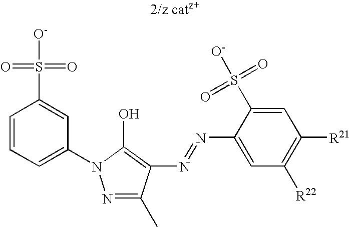
wherein R²¹ is —CH₃ and R²² is chlorine, R²¹ and R²² are chlorine, R²¹ is —CH₃ and R²² is hydrogen, or R²¹ is chlorine and R²² is —C₂H₅, cat being as defined in claim 2.

5. A process according to claim 1, wherein there is used for the dyeing at least one dye of the general formula 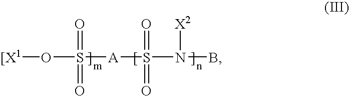
wherein m is a value from 1 to 8,
n is a value from 1 to 7, the sum of m and n being less than or equal to 8,
A, X¹, X² and B are as defined in claim 1 and
cat is an alkali metal cation, unsubstituted ammonium or an ammonium cation.

6. A process according to claim 1, wherein there is used for the dyeing at least one dye of the general formula 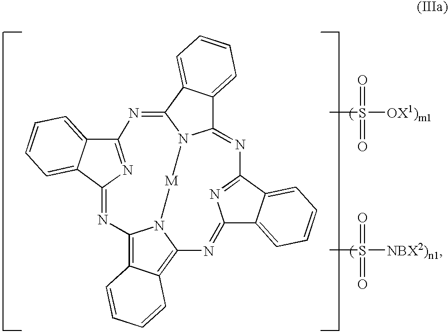
wherein M is H₂, a divalent metal selected from the group Cu(II), Zn(II), Fe(II), Ni(II), Ru(II), Rh(II), Pd(II), Pt(II), Mn(II), Mg(II), Be(II), Ca(II), Ba(II), Cd(II), Hg(II), Sn(II), Co(II) and Pb(II) or a divalent oxometal selected from the group V(O), Mn(O) and TiO, m1 is a value from 1 to 4, and n1 is a value from 1 to 4; 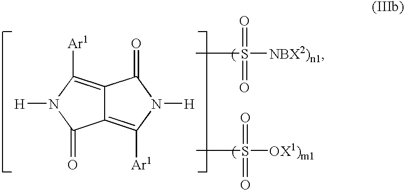
wherein Ar¹ is a group of formula 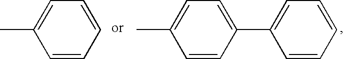
m1 is a value from 1 to 3, and n1 is a value from 1 to 3,; 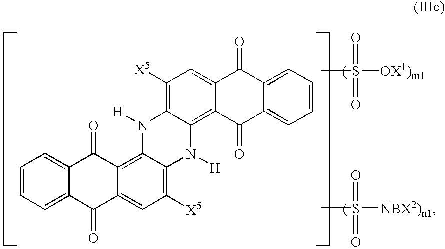
wherein X⁵ is a hydrogen or chlorine atom, m1 is a value from 1 to 4, and n1 is a value from 1 to 4; or 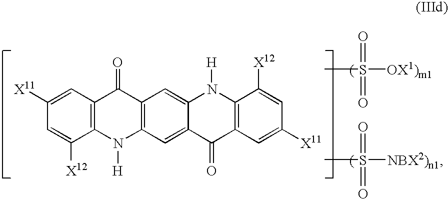
wherein X¹¹ and X¹² are each independently of the others hydrogen, a chlorine atom or a methyl group, m1 is a value from 1 to 4, and n1 is a value from 1 to 4; B is a hydrogen atom, —(CH₂)e-E or 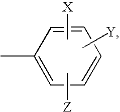
wherein e is an integer from 1 to 6, E is a hydrogen atom or a group —OH, —Ocat, —SH, —Scat, —OR¹, —SR², —NR⁵R⁶ or —C(O)OR³, and X, Y and Z are each independently of the others selected from a hydrogen atom and the groups —OH, —Ocat, —SH, —Scat, —OR¹, —SR², —NR⁵R⁶ and —C(O)OR³ wherein R¹, R² and R³are each independently of the others a C₁₋₄alkyl radical, and R⁵ and R⁶ are a -(CH₂)ₒOH radical wherein o is an integer from 2 to 6,
X¹ is a hydrogen atom or cat and
X² is a hydrogen atom or cat,
cat is a sodium or potassium cation, a calcium cation or unsubstituted ammonium or an ammonium cation.

7. A process according to claim 2, wherein the ammonium cation is a cation of the following formula 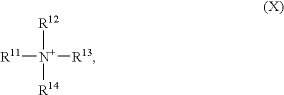
wherein R¹¹, R¹², R¹³ and R¹⁴ are independently selected from the group consisting of a hydrogen atom, unsubstituted and substituted straight-chain and branched C₁₋₃₆alkyl radicals, straight-chain and branched hydroxy-C₁₋₃₆alkyl radicals, unsubstituted and substituted C₆₋₂₄aryl radicals and unsubstituted and substituted C₇₋₂₄aralkyl radicals, including the case where two of the radicals R¹¹, R¹², R¹³ and R¹⁴, together with the nitrogen atom to which they are bonded, form a five- or six-membered heterocyclic ring, such as pyrrolidino, piperidino or morpholino.

8. A process according to claim 6, wherein the ammonium cation is selected from the group consisting of NH₄⁺, HOCH₂CH₂NH₃⁺, (HOCH₂CH₂)₂NH₂⁺, (HOCH₂CH₂)₃NH⁺, (CH₃)₂((CH₃O)₂CHCH₂)NH⁺, 1,1,3,3,5,5-hexamethylhexylammonium and

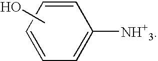

9. A process according to claim 1, wherein the dye of formula I is a dye with which a dyeing can be produced on an oxide layer, the ΔE of which dyeing after 240 hours of irradiation is less than 6.

10. A colored oxide layer obtainable according to the process according to claim 1.

11. A colored oxide layer according to claim 9 having an ΔE after 240 hours of irradiation of less than 6.

12. A colored oxide layer comprising a dye of the general formula I as defined in claim 1.

13. A colored aluminum pigment that comprises platelet-like aluminum substrates coated with a metal oxide layer, wherein the metal oxide layer comprises a dye of formula I and the metal of the metal layer is selected from vanadium, titanium, zirconium, silicon, aluminum and boron.

14. A process for the production of a colored oxide layer on aluminum or on an aluminum alloy by dyeing in an aqueous dye bath, rinsing with water and sealing, wherein the cold-or hot-sealing is carried out in the presence of an aluminum salt or a calcium salt.
